(19) United States
(12) Patent Application Publication
(10) Pub. No.: US 2004/0029754 A1
(43) Pub. Date: Feb. 12, 2004

(54) Aqueous coolant for the running-in phase of an engine containing wet chamber corosion inhibitors

(76) Inventors: Bernd Wenderoth, Birkenau (FR); Ladislaus Meszaros, Mutterstadt (DE); Uwe Nitzschke, Ludwigshafen (DE); Marco Bergemann, Hockenheim (DE)

Correspondence Address: KEIL & WEINKAUF, 1350 CONNECTICUT AVENUE, N.W., WASHINGTON, DC, 20036, US

(21) Appl. No.: 10/450,773

(22) PCT Filed: Dec. 20, 2001
(86) PCT No.: PCT/EP01/15149

(30) Foreign Application Priority Data
Dec. 22, 2000 (DE) 10064737.5

(51) Int. Cl. C09K 5/00

(52) U.S. Cl. 510/185

(57) ABSTRACT

The invention relates to aqueous coolants with wet chamber corrosion inhibiting properties, for the running-in phase of internal combustion engines, after which the coolant is run off, comprising at least one ammonium salt of an optionally substituted C₁-C₄ mono- or di-carboxylic acid.

The present invention relates to an aqueous coolant for preserving the engine flushing zone, which coolant has good vapor space corrosion inhibitor properties as a result of the addition of ammonium salts of unsubstituted or substituted C₁-C₄-mono- and/or dicarboxylic acids. The novel coolants are used during the run-in phase of newly constructed engines.

Newly constructed engines are generally subjected to brief trial and test runs after assembly. The coolants used are those based on oil or based on monoethylene glycol or monopropylene glycol. For cost reasons, the conventional coolant concentrates used in motor vehicles are frequently employed and are then diluted even further.

After a successful run-in phase, the coolant is then discharged and the engine is temporarily stored until final installation in the vehicle. Corrosion problems frequently occur since the engine flushing zone, i.e. the cooling channels, still contains residues of the coolant. As a result of evaporation, an atmossphere having a high moisture content then forms inside the engine flushing zone. This moisture can escape only very slowly, if at all. Such atmospheres are highly corrosion-promoting, with the result that various degrees of corrosion often occur during the stated storage and in some cases can be observed in various forms.

Particularly in modern internal combustion engines, thermal stresses are reached which set high requirements for the materials used. Every type and any extent of corrosion constitutes a potential risk factor and can shorten the running time of the engine and lead to a reduction in the reliability. Furthermore, a large number of different materials are increasingly being used in modern engines, for example copper, brass, soft solder, steel and magnesium and aluminum alloys. Owing to this large number of metallic materials, there are additionally potential corrosion problems, in particular at the points where different metals are in contact with one another.

A further problem is that, in the case of the use of oil-based radiator coolants, the residues remaining in the flushing zone are frequently not miscible with the regular coolants subsequently introduced. Moreover, environmentally compatible disposal is more difficult.

There is therefore a need for coolants by means of which effective preservation of the engine flushing zone is permitted in engines after a successful run-in phase and after discharge of the coolant. A precondition for this is very good corrosion protection of the vapor space. These coolants should furthermore be compatible with the regular coolants and should be capable of being disposed of in an environmentally compatible manner.

The prior art contains references which describe vapor space corrosion inhibitors generally.

DE 184 725 discloses the use of nitrites of the alkali metals and alkaline earth metals in combination with phosphates of secondary amines in corrosion-preventing packaging material.

In J. Appl. Chem. 2 (1952), 166 to 172, E. G. Stroud and W. H. J. Vernon describe the use of sodium benzoate as a corrosion inhibitor in packaging materials.

DD-P-14 440 discloses a corrosion-inhibiting packaging material in which ammonium nitrites were applied together with cationic wetting agents.

German Published Application DAS 2,141,393 describes a corrosion-preventing packaging material which comprises a paper material having a specific fiber length, and oil-soluble products from petrochemical synthesis are used as inhibitors, preferably salts of benzoic acid.

U.S. Pat. No. 4,124,549 describes the use of salts of specific carboxylic acids, including benzoic acid, with organic amines as vapor space corrosion inhibitors. The salts are incorporated into a thermoplastic resin which is used as a packaging material after extrusion.

All of the abovementioned references disclose vapor space corrosion inhibitors which are applied in or on packaging materials.

Other references disclose corrosion inhibitors which have a corrosion inhibiting effect in the vapor space and can generally be used for corrosion prevention in metallic interiors.

In DD-P-298 662, this is, for example, a mixture consisting of from 2.1 to 250 g/l of ammonium benzoate, from 0.5 to 60 g/l of p-hydroxybenzoic ester, from 1 to 120 g/l of benzotriazole and from 0.4 to 50 g/l of dimethylaminoethanol, and EP-A-221 212 proposes an aqueous mixture which has a corrosion-inhibiting effect in the vapor space and contains an alkylene glycol, if required a polyalkylene glycol, and, as corrosion inhibitor, a polyoxyalkyleneamine having a specific weight ratio of oxyethylene to oxypropylene.

Frequently, benzoates are used in combination with other substances in mixtures preventing vapor space corrosion, and the use of benzoates in cooling liquids of internal combustion engines has also long been known. These liquids are generally formulated in such a way that they are used for preventing corrosion in the liquid space.

Thus, WO 97/30133 describes corrosion-inhibiting mixtures for use as coolants in internal combustion engines, which contain quaternized imidazoles as an active ingredient. Inter alia, the sodium salts of benzoic acid are mentioned as further components which may be present. These mixtures serve for preventing corrosion which can occur in the liquid space of the cooling channels of internal combustion engines.

Corrosion-inhibiting mixtures which are likewise used for preventing corrosion in the liquid space of the cooling channels of internal combustion engines are also disclosed in EP-A-816 467. The mixtures described there contain from 0.5 to 10 percent by weight of a carboxylic acid of 3 to 16 carbon atoms in the form of its alkali metal, ammonium or substituted ammonium salts and from 0.01 to 3% by weight of at least one hydrocarbon-triazole and/or hydrocarbon-thiazole, in particular benzotriazole and/or tolutriazole. The carboxylic acid which may be used is, inter alia, benzoic acid. The mixtures present as antifreeze concentrates are silicate-, borate- and nitrate-free.

Finally, U.S. Pat. No. 4,711,735 describes a complex mixture for preventing corrosion and deposits in cooling systems of internal combustion engines. This mixture contains from 0.017 to 0.42% of ricinoleic acid, from 0.007 to 0.083% of benzotriazole, from 0.5 to 1.5% of mercaptobenzothiazole, from 0.17 to 4% of styrene/maleic anhydride having a molecular weight of from 200 to 3 500, from 0.42 to 2% of benzoic acid, from 0.42 to 4.0% of salt of benzoic acid, from 0.33 to 3.3% of nitrite, from 0.37 to 3.7% of nitrate and from 0.42 to 3% of carboxymethylmercaptosuccinic acid. The corrosion in the liquid space is said to be prevented thereby, it also being mentioned that a corrosion-inhibiting effect in the vapor space can occur.

WO 00/22190 describes aqueous engine run-in compositions which have a corrosion-inhibiting effect in the vapor space and contain one or more ammonium salts of carboxylic acids of 5 to 18, particularly preferably 6 to 12, carbon atoms.

There is furthermore a need for coolants which provide effective corrosion inhibition in the vapor space and do not have the disadvantages of the coolants described in the prior art.

It is an object of the present invention to provide an aqueous coolant for internal combustion engines which permits effective corrosion inhibition in the vapor space in engine flushing zones from which the coolant has been removed and which are subsequently stored. In addition to having adequate activity as a corrosion inhibitor, the coolant should be economical, obtainable only by slight manipulations of commercial cooling liquids or coolant concentrates for internal combustion engines and capable of being disposed of in an environmentally compatible manner.

We have found that this object is achieved by the use of ammonium salts of C₁-C₄-mono- and dicarboxylic acids which may contain one or more OH substituents as vapor space corrosion inhibitors in aqueous coolants in the run-in phase of internal combustion engines, where the coolant is discharged from the engine cooling circuit after the run-in phase.

We have found that this object is furthermore achieved by an aqueous coolant having corrosion-inhibiting properties in the vapor space for the run-in phase of internal combustion engines, after which the coolant is discharged, containing at least one ammonium salt of a C₁-C₄-mono- or dicarboxylic acid which may have one or more OH substituents, in addition to the conventional accompanying substances and assistants.

We have found that, by adding the ammonium salts of the short-chain acids defined above to coolants, extremely effective preservation of the engine flushing zone and hence prevention of vapor space corrosion can be achieved. This preservation effect occurs when the coolant is discharged from the cooling circuit, for example after the run-in phase, and the engine is then stored. The vapor space corrosion inhibition achieved is frequently superior-to that which is achieved with the ammonium salts of longer-chain fatty acids used, for example, in WO 00/22190.

According to the invention, ammonium salts of unsubstituted or of OH-substituted C₁-C₄-mono- and dicarboxylic acids, each of which may be linear or branched, can be used. One or more substituents may be present. Examples of suitable mono- or dicarboxylic acids which can be used according to the invention are formic acid, acetic acid, propionic acid, butyric acid, oxalic acid, malonic acid, succinic acid and lactic acid.

Only one specific C₁-C₄-mono- or dicarboxylic acid or a mixture of two or more of said acids, in each case in the form of the ammonium salt, may be used.

The ammonium cations used may be cations of the NH₄⁺, monoalkylammonium, dialkylammonium and trialkylammonium type. If the ammonium cations have alkyl radicals, these may be linear or branched, cyclic or acyclic. They preferably have from 1 to 6 carbon atoms. The alkyl radicals may be unsubstituted or may have one or more OH substituents.

Examples of alkyl radicals present on the ammonium cation are methyl, ethyl, propyl, butyl, isopropyl, tert-butyl, pentyl, cyclohexyl and hydroxyethyl.

Preferred ammonium cations are NH₄⁺, mono-, di- and triethylammonium and mono-, di- and triethanolammonium.

NH₄⁺ and ethanolammonium cations are particularly preferred, for example the triethanolammonium cation.

The novel salts are present in the aqueous coolant, which is introduced into the cooling channels of the engine, in concentrations of ≦10, preferably from 0.1 to 5, % by weight. A particularly preferred concentration range is from 0.1 to 1% by weight. The coolants used may contain the conventional accompanying substances and assistants known to a person skilled in the art. These are, for example, monoethylene glycol, monopropylene glycol, glycerol, longer-chain mono- and dicarboxylic acids and their alkali metal salts, triazole derivatives, imidazole derivatives, silicates, nitrites, nitrates, phosphates, alkali metal hydroxides, thiazole derivatives, pyrrolidone derivatives, polyacrylates, salts of alkaline earth metals, molybdates, tungstates, phosphonates and borates.

The novel coolants having a corrosion-inhibiting effect in the vapor space are most simply prepared from the conventional, commercially available coolants by appropriate dilution and addition of the novel salt. The novel coolants contain water in an amount of from 80 to 98, preferably from 90 to 95, percent by weight.

By simple addition of the novel salts, it is possible to obtain coolants having a pronounced corrosion-inhibiting effect in the vapor space. Such coolants can advantageously be used during the run-in phase of internal combustion engines, after which the coolant is removed from the cooling circuit of the engine and the engines are temporarily stored.

The examples which follow illustrate the invention. The novel cooling liquids used were prepared by the following method, the amount of the respective substance stated in the corresponding example being used.

About 4% by weight of distilled water are initially taken and then 50% strength NaOH or KOH solution, benzotriazole, tolutriazole and 4-hydroxybenzoic acid, 2-ethylhexanoic acid, adipic acid and/or sebacic acid are added while stirring, a pH of about 7.5 being reached. Monoethylene glycol and, if required, aqueous polyvinylpyrrolidone solution are then added in succession. In examples A to A10, a solution of sodium metasilicate.5H₂O and sodium silicophosphonate and monoethylene glycol is added at below 50° C.; the salt of the respective carboxylic acid is then added (except for example A). Finally, dilution is effected with the still lacking amount of distilled water while stirring, a clear, colorless liquid being obtained.

The novel aqueous mixtures are tested in the vapor space corrosion test described below:

### EXAMPLES A T A10 AND B TO B2

Vapor Space Corrosion Test

3 gray cast iron strips cut from cylinder liners and having a length of 130 mm, a width of 15-25 mm and a depth of 11 mm (approximate values) are required per test. After deburring of the outermost cut edges of new test strips with a file, the strips are cleaned with a Kleenex tissue moistened with acetone until all adhering impurities have been completely removed.

Three cylinder liner strips are placed perpendicularly and in each case crosswise relative to the next strip in a 1000 ml beaker (from Schott, Duran, graduated, low form with spout) and the test solution to be tested, which was heated to the boil beforehand, is poured over said strips so that the cylinder liner strips are completely covered with the test solution.

The beaker is then covered with a watchglass and is left to stand for one hour at room temperature. Thereafter, the test solution is poured off to the 300 ml mark and the beaker is sealed vapor-tight with three layers of Parafilm (M Laboratory Film, American National Can, Chicago, II. 60631).

The cylinder liner strips are stored in this moist atmosphere for 10 days at room temperature. After this time, they are removed, immediately rinsed with distilled water and then with acetone and dried. The visual assessment for the vapor space, liquid and interface between vapor space and liquid is then carried out.

The test results are shown in table 2. Whereas corrosion occurred on the gray cast iron test strips with the use according to comparative example A in the vapor space, and in the vapor space, in the liquid and at the interface with the use according to comparative example B, the corrosion could be completely prevented by the use of the novel aqueous coolants A1 to A8 and B1; with the ammonium salts of longer-chain carboxylic acids according to WO 00/22190 (examples A 9, A 10 and B2), the vapor space corrosion could not be sufficiently prevented, in contrast to the examples according to the invention.

TABLE 1
Composition of the novel aqueous coolants:

| Examples: | A | | | | |
|---|---|---|---|---|---|
| Components [% by wt.] | (comp.) | A1 | A2 | A3 | A4 |
| Water | 94.049 | 94.049 | 94.049 | 94.049 | 94.049 |
| Monoethylene glycol | 2.926 | 2.726 | 2.626 | 2.826 | 2.626 |
| 2-Ethylhexanoic acid | 1.330 | 1.330 | 1.330 | 1.330 | 1.330 |
| Adipic acid | — | — | — | — | — |
| Sebacic acid | — | — | — | — | — |
| 50% strength NaOH | — | — | — | — | — |
| 50% strength KOH | 1.240 | 1.240 | 1.240 | 1.240 | 1.240 |
| 4-Hydroxybenzoic acid | 0.210 | 0.210 | 0.210 | 0.210 | 0.210 |
| Sodium metasilicate · 5H₂O | 0.017 | 0.017 | 0.017 | 0.017 | 0.017 |
| Sodium silicophosphonate | 0.102 | 0.102 | 0.102 | 0.102 | 0.102 |
| Benzotriazole | 0.053 | 0.053 | 0.053 | 0.053 | 0.053 |
| Tolutriazole | 0.053 | 0.053 | 0.053 | 0.053 | 0.053 |
| Polyvinylpyrrolidone | 0.020 | 0.020 | 0.020 | 0.020 | 0.020 |
| 50% strength magnesium | — | — | — | — | — |
| acetate · 4H₂O | | | | | |
| Ammonium propionate | — | 0.200 | 0.300 | — | — |
| Ammonium acetate | — | — | — | 0.100 | 0.300 |
| Triethanolammonium propionate | — | — | — | — | — |
| Ammonium oxalate | — | — | — | — | — |
| Ammonium succinate | — | — | — | — | — |
| Triethanolammonium | — | — | — | — | — |
| 2-hydroxypropionate | | | | | |
| Ammonium 2-ethylhexanoate | — | — | — | — | — |
| Triethanolammonium | — | — | — | — | — |
| 2-ethylhexanoate | | | | | |

| Examples: | | | | | A9 |
|---|---|---|---|---|---|
| Components [% by wt.] | A5 | A6 | A7 | A8 | (WO 00/22190) |
| Water | 94.049 | 94.049 | 94.049 | 94.049 | 94.049 |
| Monoethylene glycol | 2.726 | 2.726 | 2.726 | 2.726 | 2.626 |
| 2-Ethylhexanoic acid | 1.330 | 1.330 | 1.330 | 1.330 | 1.330 |
| Adipic acid | — | — | — | — | — |
| Sebacic acid | — | — | — | — | — |
| 50% strength NaOH | — | — | — | — | — |
| 50% strength KOH | 1.240 | 1.240 | 1.240 | 1.240 | 1.240 |
| 4-Hydroxybenzoic acid | 0.210 | 0.210 | 0.210 | 0.210 | 0.210 |
| Sodium metasilicate · 5H₂O | 0.017 | 0.017 | 0.017 | 0.017 | 0.017 |
| Sodium silicophosphonate | 0.102 | 0.102 | 0.102 | 0.102 | 0.102 |
| Benzotriazole | 0.053 | 0.053 | 0.053 | 0.053 | 0.053 |
| Tolutriazole | 0.053 | 0.053 | 0.053 | 0.053 | 0.053 |
| Polyvinylpyrrolidone | 0.020 | 0.020 | 0.020 | 0.020 | 0.020 |
| 50% strength magnesium | — | — | — | — | — |
| acetate · 4H₂O | | | | | |
| Ammonium propionate | — | — | — | — | — |
| Ammonium acetate | — | — | — | — | — |
| Triethanolammonium | 0.200 | — | — | — | — |
| propionate | | | | | |
| Ammonium oxalate | — | 0.200 | — | — | — |
| Ammonium succinate | — | — | 0.200 | — | — |
| Triethanolammonium | — | — | — | 0.200 | — |
| 2-hydroxypropionate | | | | | |
| Ammonium | — | — | — | — | 0.300 |
| 2-ethylhexanoate | | | | | |
| Triethanolammonium | — | — | — | — | — |
| 2-ethylhexanoate | | | | | |

| | A10 | | | B2 |
|---|---|---|---|---|
| Examples: | (WO | B | | (WO |
| Components [% by wt.] | 00/22190) | (Comparison) | B1 | 00/22190) |
| Water | 94.049 | 90.000 | 90.000 | 90.000 |
| Monoethylene glycol | 2.526 | 9.326 | 9.126 | 9.126 |
| 2-Ethylhexanoic acid | 1.330 | — | — | — |
| Adipic acid | — | 0.070 | 0.070 | 0.070 |
| Sebacic acid | — | 0.280 | 0.280 | 0.280 |
| 50% strength NaOH | — | 0.298 | 0.298 | 0.298 |
| 50% strength KOH | 1.240 | — | — | — |
| 4-Hydroxybenzoic acid | 0.210 | — | — | — |
| Sodium metasilicate · 5H₂O | 0.017 | — | — | — |
| Sodium silicophosphonate | 0.102 | — | — | — |
| Benzotriazole | 0.053 | — | — | — |
| Tolutriazole | 0.053 | 0.020 | 0.020 | 0.020 |
| Polyvinylpyrrolidone | 0.020 | — | — | — |
| 50% strength magnesium | — | 0.006 | 0.006 | 0.006 |
| acetate · 4H₂O | | | | |
| Ammonium propionate | — | — | 0.200 | — |
| Ammonium acetate | — | — | — | — |
| Triethanolammonium | — | — | — | — |
| propionate | | | | |
| Ammonium oxalate | — | — | — | — |
| Ammonium succinate | — | — | — | — |
| Triethanolammonium | — | — | — | — |
| 2-hydroxypropionate | | | | |
| Ammonium | — | — | — | 0.200 |
| 2-ethylhexanoate | | | | |
| Triethanolammonium | 0.400 | — | — | — |
| 2-ethylhexanoate | | | | |

TABLE 2
Results in the vapor space corrosion test

| Examples: | A | | | | | | | | |
|---|---|---|---|---|---|---|---|---|---|
| Rating: | (Comp.) | A1 | A2 | A3 | A4 | A5 | A6 | A7 | A8 |
| Vapor space | 3 | 1 | 1 | 1 | 1 | 1 | 1 | 1 | 1 |
| Liquid | 1 | 1 | 1 | 1 | 1 | 1 | 1 | 1 | 1 |
| Interface | 1 | 1 | 1 | 1 | 1 | 1 | 1 | 1 | 1 |

| Examples: | A9 | A10 | B | | B2 |
|---|---|---|---|---|---|
| Rating: | (WO 00/22190) | (WO 00/22190) | (Comp.) | B1 | (WO 00/22190) |
| Vapor space | 2 | 2 | 2 | 1 | 2 |
| Liquid | 2 | 1 | 3 | 1 | 1 |
| Interface | 1 | 1 | 3 | 1 | 1 |

Rating scale:
1 No corrosion
2 Slight corrosion (<1% of the metal surface corroded)
3 Corrosion (>1% of the metal surface corroded)

We claim:

1. The use of ammonium salts of unsubstituted or substituted C₁-C₄-mono- and dicarboxylic acids as vapor space corrosion inhibitors in aqueous coolants in the run-in phase of internal combustion engines, where the coolant is discharged from the engine cooling circuit after the run-in phase is complete.

2. The use as claimed in claim 1, wherein the salt of the unsubstituted or substituted mono- or dicarboxylic acid is present in the coolant in an amount of ≦10, preferably from 0.1 to 5, in particular from 0.1 to 1, % by weight.

3. The use as claimed in claim 1 or 2, wherein the mono- and/or dicarboxylic acid used is unsubstituted or has an OH substituent.

4. The use as claimed in any of claims 1 to 3, wherein the carboxylic acid is selected from the group consisting of formic acid, acetic acid, propionic acid, butyric acid, oxalic acid, malonic acid, succinic acid and lactic acid.

5. The use as claimed in any of claims 1 to 4, wherein the ammonium ion is selected from the group consisting of NH₄⁺ ions and monoalkyl-, dialkyl- and trialkylammonium ions of unsubstituted or OH-substituted C₁-C₆-alkyl radicals, preferably from the group consisting of NH₄⁺, mono-, di- and triethylammonium ions and mono-, di- and triethanolammonium ions, in particular NH₄⁺ and triethanolammonium ions.

6. An aqueous coolant having corrosion-inhibiting properties in the vapor space for the run-phase of internal combustion engines, after which the coolant is discharged, containing at least one ammonium salt of a C₁-C₄-mono- or dicarboxylic acid which may have one or more OH substituents, in addition to the conventional accompanying substances and assistants.

7. An aqueous coolant as claimed in claim 6, wherein the salt of the unsubstituted or substituted mono- or dicarboxylic acid is present in the coolant in an amount of ≦10, preferably from 0.1 to 5, in particular from 0.1 to 1, % by weight.

8. An aqueous coolant as claimed in claim 6 or 7, wherein the carboxylic acid is selected from the group consisting of formic acid, acetic acid, propionic acid, butyric acid, oxalic acid, malonic acid, succinic acid and lactic acid.

9. An aqueous coolant as claimed in any of claims 6 to 8, wherein the ammonium ion is selected from the group consisting of NH₄⁺ ions and monoalkyl-, dialkyl- and trialkylammonium ions of unsubstituted or OH-substituted C₁-C₆-alkyl radicals, preferably from the group consisting of NH₄⁺ ions, mono-, di- and triethylammonium ions and mono-, di- and triethanolammonium ions, in particular NH₄⁺ and triethanolammonium ions.

10. An aqueous coolant as claimed in any of claims 6 to 9, wherein the accompanying substances and assistants used are selected from the group consisting of monoethylene glycol, monopropylene glycol, glycerol, longer-chain mono- and dicarboxylic acids and their alkali metal salts, triazole derivatives, imidazole derivatives, silicates, nitrites, nitrates, phosphates, alkali metal hydroxides, thiazole derivatives, pyrrolidone derivatives, polyacrylates, salts of alkaline earth metals, molybdates, tungstates, phosphonates and borates.
